(19) United States
(12) Patent Application Publication
(10) Pub. No.: US 2022/0323293 A1
(43) Pub. Date: Oct. 13, 2022

(54) FREE-STANDING SWINGING AND/OR HANGING SEAT FOR EROTIC PURPOSES

(71) Applicant: Martin Tucker, Tarzana, CA (US)

(72) Inventor: Martin Tucker, Tarzana, CA (US)

(21) Appl. No.: 17/718,180

(22) Filed: Apr. 11, 2022

Related U.S. Application Data
(60) Provisional application No. 63/173,190, filed on Apr. 9, 2021.

(51) Int. Cl. A61H 19/00; A47C 15/00

(52) U.S. Cl. CPC A61H 19/44; A61H 19/50; A47C 15/008; A61H 2201/1607; A61H 2201/1626; A61H 2201/1633; A61H 2201/0107; A61H 2201/0173; A61H 23/00

(57) ABSTRACT

A sex swing apparatus comprising: an upper strap, a middle strap, and a lower strap provided with an enlarged seat area, and attached on either side to upright bars via connection points, wherein the upper strap and the middle strap are provided with an upper cushion and a middle cushion to support a user's head and lower back, respectively; a pocket integrated onto the lower strap for securely disposing of a solid or a rigid piece onto the lower strap, to create a solid or rigid seat area for the user to sit on; a crossbar detachably attached between plates, wherein the crossbar and the upright bars are held by legs detachably coupled at one end to the plates and at other end to a ground surface; and a front bar coupled at one end to the crossbar and at other end to a front leg, wherein the front bar extends normally outwards from the crossbar towards the front leg, the front leg comprises: a front connection curved arm attached to the front leg and curved towards the lower strap; and a phallic device detachably attached to the front connection curved arm towards the lower strap, wherein the phallic device is being positioned by moving the front connection curved arm, up, down, backward, and forward from the lower strap.

### CROSS-REFERENCE TO RELATED APPLICATION

This application claims the benefit of U.S. Provisional Patent Application Ser. No. 63/173,190 filed Apr. 9, 2021, titled “Free-Standing Swinging and/or Hanging Seat for Erotic Purposes,” and the subject matter thereof is incorporated herein by reference thereto.

### TECHNICAL FIELD

The present invention relates to a swing or hanging seat for erotic purposes, and more specifically to a free-standing swing.

### BACKGROUND ART

Devices known as “sex swings” are well-known in the prior art. Simply put, a sex swing is a device that lifts and suspends one partner off the ground while the other partner(s) have the ability to move around the suspended partner freely in order to engage in sex. These swings provide flexibility and variety for sexual activity.

Many of the prior art sex swings have one or more hooks that must be installed in the ceiling. This requires a permanent installation and is difficult to install. Failure to install correctly in the ceiling (i.e., hit the beam right in the middle) could be disastrous. Some sex swings are free-standing, but they are clunky, hard to use, and require a partner, and are typically more expensive than the swings that mount to the ceiling.

U.S. Pat. No. 5,971,480, Maschke, entitled, “Spinning and/or Swinging, Hanging Seat for Erotic Purposes, is such a device for a sex swing that is mounted to the ceiling. Like most sex swings in the prior art, there is one connection point at the top, thus requiring an additional piece to separate the two sides of the seat. This can cause problems.

Despite the abundance of sex swings, there is a shortage of devices of apparatuses that provide a free-standing sex swing that is easy to use, easy to set-up, easy to take down and store, collapsible, can be used with or without a partner, modular, and inexpensive. The prior art invention overcomes the shortcoming contained in the prior art by providing a such a device that provides all of those features.

Certain embodiments of the invention have other steps or elements in addition to or in place of those mentioned above. The steps or element will become apparent to those skilled in the art from a reading of the following detailed description when taken with reference to the accompanying figures.

None of the prior art fully addresses the problems resolved by the present invention. The present invention overcomes these limitations contained in the prior art by providing a child restraint apparatus for children that is sturdy, reliable, easy to use, safe, and inexpensive.

### BRIEF DESCRIPTION OF THE DRAWINGS

FIG. 1 illustrates a perspective view of the sex swing apparatus of the present invention;

FIG. 2 illustrates a front view of the sex swing apparatus of the present invention; and

FIG. 3 illustrates a left side view of the sex swing apparatus of the present invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures. The term “on” means that there is direct contact among elements.

The present invention provides a free-standing sex swing that is easy to use, easy to set-up, easy to take down and store, collapsible, can be used with or without a partner, modular, and inexpensive.

The present invention provides a sex swing apparatus comprising: an upper strap, a middle strap, and a lower strap provided with an enlarged seat area, and attached on either side to upright bars via connection points, wherein the upper strap and the middle strap are provided with an upper cushion and a middle cushion to support a user's head and lower back, respectively; a pocket integrated onto the lower strap for securely disposing of a solid or a rigid piece onto the lower strap, to create a solid or rigid seat area for the user to sit on; a crossbar detachably attached between plates, wherein the crossbar and the upright bars are held by legs detachably coupled at one end to the plates and at other end to a ground surface; and a front bar coupled at one end to the crossbar and at other end to a front leg, wherein the front bar extends normally outwards from the crossbar towards the front leg, the front leg comprises: a front connection curved arm attached to the front leg and curved towards the lower strap; and a phallic device detachably attached to the front connection curved arm towards the lower strap, wherein the phallic device is being positioned by moving the front connection curved arm, up, down, backward, and forward from the lower strap.

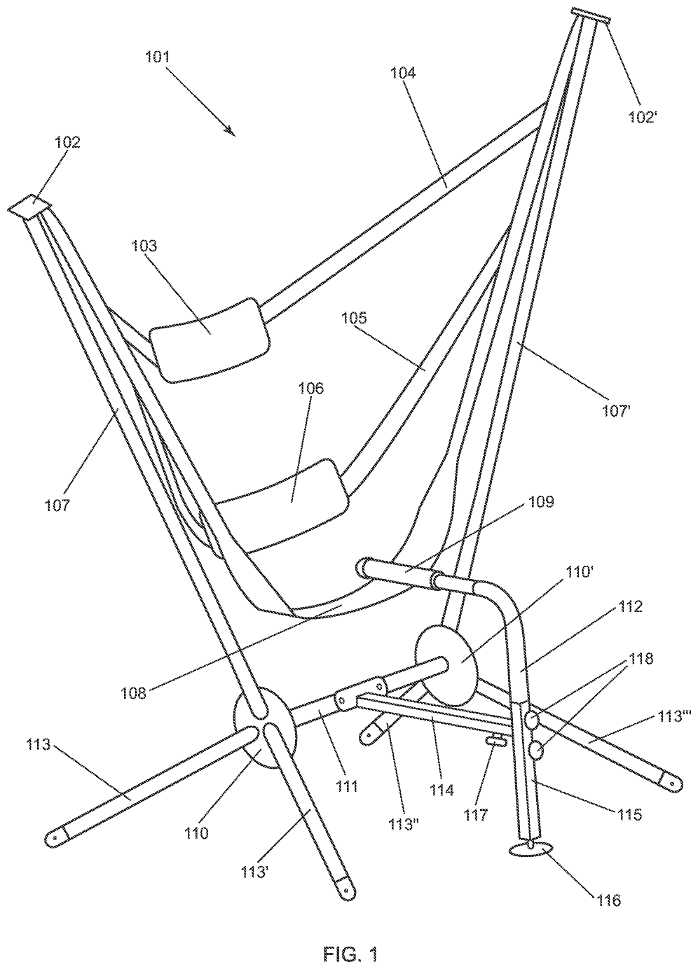

FIG. 1 shows a perspective view of sex swing 101 of the present invention. Upper strap 104, middle strap 105, and lower strap 108 are each attached to top of upright bars 107 and 107′ at connection points 102 and 102′. Upper strap 104 and middle strap 105 comprise upper cushion 103 and middle cushion 106 respectively to support the user's head and back/butt, respectively, in order to suspend them. Lower strap 108 comprises an enlarged seat area for user.

Lower strap 108 comprises a pocket or other attachment point whereby a solid and/or rigid piece can be securably disposed on or into lower strap 108 in order to create a solid and/or rigid seat area for the user to sit on. Lower strap 108 may also comprises an attachment point for a dildo or other sexual stimulation device to be attached. The pocket in lower strap 108 may contain different sizes of seats based on the user's desires. The seat may be rigid, soft, or otherwise. The pocket of lower strap 108 can remain empty if so desired.

Upright bar 107, legs 113 and 113′, and crossbar 111 are all modular and are attachably disposed in plate 110, and upright bar 107′, legs 113″ and 113′″, and crossbar 111 are all modular and are attachably disposed in plate 110′. Each of those pieces can be removed from plates 110 and 110′ in order to dismantle sex swing 101. Front bar 114 is attachably connected to crossbar 111 and extends outward from crossbar 111. Front bar terminates at front leg 115, which comprises foot 116. Front connection curved arm 112 is attached to front leg 115 and curves toward the user when positioned in the sex swing 101. Phallic device 109 is removably attached to front connection curved arm 112. Twist knobs 117 and 118 allow for the position of phallic device 109 by moving front connection curved arm 112 up down, backwards, and forwards, from the user's perspective.

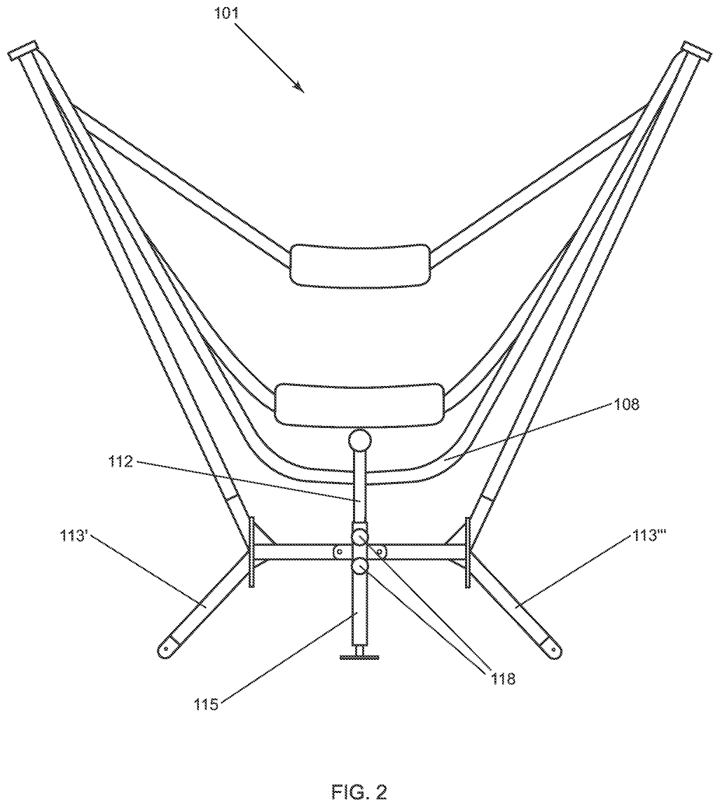

FIG. 2 shows a front view of sex swing 101 of the present invention.

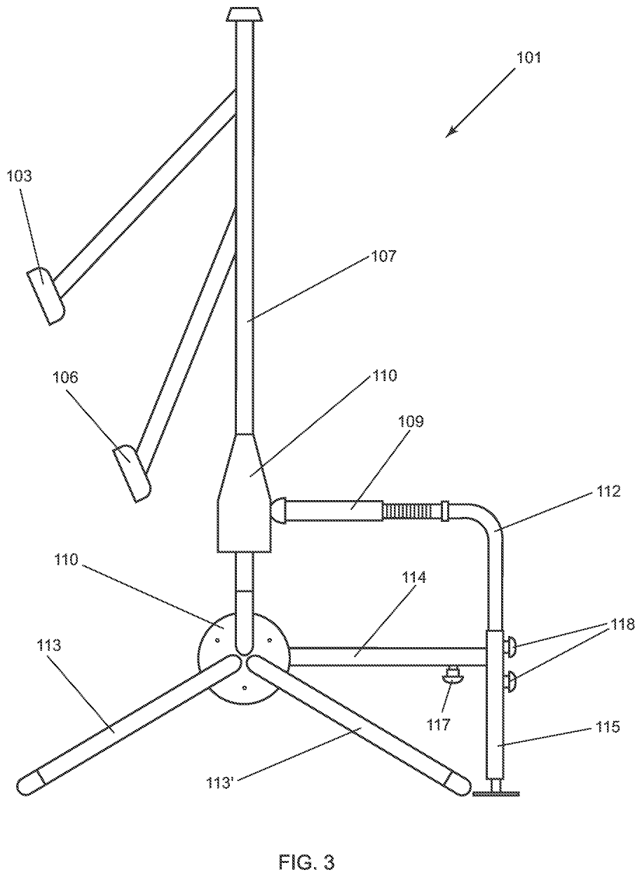

FIG. 3 shows a left side view of sex swing 101 of the present invention.

The ability for the placement of phallic device 109 allows sex swing 101 of the present invention to be used without a partner. Front bar 114 can be easily removed from sex swing 101 to allow for partner use, as desired.

Any number of sexual apparatuses may be attached to front connection curved arm 112, as may be desired by the user.

Front connection curved arm 112 may comprise vibrating or other mechanical movement whereby the dildo or other sexual apparatus moves.

Connection points 102 and 102′ may comprises a mechanism that allows for the length of Upper strap 104, middle strap 105, and/or lower strap 108 to be adjusted.

Upper cushion 103 and middle cushion 106 can be removable and may comprise any size, shape, material, hardness, and/or placement as desired.

Leg 113, 113′, 113″, and 113′″ may comprise telescoping features in order to better stabilize sex swing 101, with feet or other attachment at the distal ends.

A seat belt or seat belts may be added to sex swing 101 to ensure that the user does not fall out of sex swing 101.

Sex swing 101 may include vibration and/or thrusting of phallic device 109.

Any number of straps and/or seats may be utilized in the sex swing 101 of the present invention.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A sex swing apparatus comprising:
an upper strap, a middle strap, and a lower strap provided with an enlarged seat area, and attached on either side to upright bars via connection points, wherein the upper strap and the middle strap are provided with an upper cushion and a middle cushion to support a user's head and lower back, respectively;
a pocket integrated onto the lower strap for securely disposing of a solid or a rigid piece onto the lower strap, to create a solid or rigid seat area for the user to sit on;
a crossbar detachably attached between plates, wherein the crossbar and the upright bars are held by legs detachably coupled at one end to the plates and at other end to a ground surface; and
a front bar coupled at one end to the crossbar and at other end to a front leg, wherein the front bar extends normally outwards from the crossbar towards the front leg, the front leg comprises:
a front connection curved arm attached to the front leg and curved towards the lower strap; and
a phallic device detachably attached to the front connection curved arm towards the lower strap, wherein the phallic device is being positioned by moving the front connection curved arm, up, down, backward, and forward from the lower strap.

2. The sex swing apparatus of claim 1, wherein the phallic device is being positioned by moving the front connection curved arm, up, down, backward, and forward from the lower strap, using twist knobs disposed on the front bar and the front leg.

3. The sex swing apparatus of claim 1, wherein the lower strap comprises an attachment point for a dildo or other sexual stimulation device to be attached.

4. The sex swing apparatus of claim 1, wherein the legs, the upright bar, and the crossbar are modular pieces and detachable from the plates to dismantle the sex swing apparatus.

5. The sex swing apparatus of claim 1, wherein the front leg is provided with a foot towards the ground surface.

6. The sex swing apparatus of claim 1, wherein the upright bars are detachably coupled to the plates.

7. The sex swing apparatus of claim 1, wherein the upper strap, the middle strap, and the lower strap, are attached on either side to the upright bars.

8. The sex swing apparatus of claim 1, wherein the front connection curved arm allows any number of sexual apparatuses to be attached, according to a desire of the user.

9. The sex swing apparatus of claim 1, wherein the front connection curved arm is provided with a vibrating movement to move the phallic device towards the user.

10. The sex swing apparatus of claim 1, wherein the connection points comprise a mechanism that allows for a length adjustment of the upper strap, the middle strap, and the lower strap.

11. The sex swing apparatus of claim 1, wherein the upper cushion and the middle cushion are removably coupled to the sex swing apparatus.

12. The sex swing apparatus of claim 1, wherein the upper cushion and the middle cushion vary according to size, shape, material, hardness, and/or placement as desired.

13. The sex swing apparatus of claim 1, wherein the legs include telescoping features to stabilize the sex swing apparatus, with feet at the other end of the legs.

14. The sex swing apparatus of claim 1, wherein the phallic device mounted on the front connection curved arm, is thrusted and vibrated.

15. The sex swing apparatus of claim 1, wherein the sex swing apparatus is used without a partner by removing the front bar between the crossbar and the front leg.
